(19) United States
(12) Patent Application Publication
(10) Pub. No.: US 2009/0057594 A1
(43) Pub. Date: Mar. 5, 2009

(54) BLEED VALVE APPARATUS

(75) Inventor: Hiroo Tsujimoto, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/193,293

(22) Filed: Aug. 18, 2008

(30) Foreign Application Priority Data
Aug. 30, 2007 (JP) 2007-224616

(51) Int. Cl. F16K 1/00

(52) U.S. Cl. 251/324

(57) ABSTRACT

A valve body has an annular bottom face and an inner circumferential periphery both defining a seat fitting hole, which is coaxial with a sliding hole. A spool is axially movable in the sliding hole. A seat member has an axial end surface and an outer circumferential periphery, which are respectively axially and radially press-fitted to the annular bottom face and the inner circumferential periphery to respectively define an annular seal portion and a cylindrical seal portion therebetween. The seat member has a bleed port for draining fluid from a bleed chamber. The spool has an end surface, which defines a small clearance between the end surface and the seat member when the spool is seated to the seat member for communicating a supply port with the bleed chamber.

### CROSS REFERENCE TO RELATED APPLICATIONS

This application is based on and incorporates herein by reference Japanese Patent Application No. 2007-224616 filed on Aug. 30, 2007.

### FIELD OF THE INVENTION

The present invention relates to a bleed valve apparatus having a bleed chamber for hydraulically manipulating a spool.

### BACKGROUND OF THE INVENTION

For example, U.S. Pat. No. 6,615,869 B2 (JP-A-2002-357281) discloses a bleed valve apparatus as an example of a solenoid hydraulic pressure control valve, which actuates a spool by applying hydraulic pressure in a bleed chamber. The solenoid hydraulic pressure control valve disclosed in U.S. Pat. No. 6,615,869 B2 is described with reference to FIGS. 4, 5A, 5B. A solenoid hydraulic pressure control valve is configured to actuate a spool 4, which is slidable in a sliding hole 6 of a sleeve 3, by applying pressure axially from a bleed chamber 34. The solenoid hydraulic pressure control valve includes a spool valve 1 and a solenoid bleed valve 2. The spool valve 1 includes the sleeve 3, the spool 4, and a spool-return spring 5. The spool-return spring 5 biases the spool 4 along a slidable direction to the right in FIG. 4. The solenoid bleed valve 2 controls pressure in the bleed chamber 34.

The solenoid bleed valve 2 includes a seat member 31, a valve 32, and a solenoid actuator 33. The seat member 31 and the spool 4 therebetween define a bleed chamber 34, to which pressurized oil is supplied. The seat member 31 has a bleed port 35, which communicates the bleed chamber 34 with a low-pressure component. The valve 32 opens and closes the bleed port 35. The solenoid actuator 33 actuates the valve 32. When the spool 4 is seated to the seat member 31, a supply port 12 is substantially blockaded from the bleed chamber 34 by the spool 4, whereby supply of oil through the supply port 12 is stopped. When the spool 4 is lifted from the seat member 31, the supply port 12 communicates with the bleed chamber 34.

The seat member 31 is substantially in a cylindrical shape and has the bleed chamber 34 therein. The seat member 31 is inserted to a seat fitting hole 61, which is substantially coaxial with the sliding hole 6. The seat member 31 is fixed to the sleeve 3 by being press-fitted, for example.

The seat fitting hole 61 has the diameter larger than the diameter of the sliding hole 6. The seat fitting hole 61 has a bottom end with respect to the axial direction, in which the seat member 31 is inserted. The bottom end of the seat fitting hole 61 defines an annular step (annular bottom face) 61a. The end surface of the seat member 31 has a first seat face M1 and a second seat face M2. The first seat face M1 is substantially in an annular shape and axially press-fitted to the annular bottom face 61a of the seat fitting hole 61. The second seat face M2 is substantially in an annular shape, and configured to make contact with the end surface of the spool 4 when the spool 4 is seated.

In the state where the seat member 31 is inserted into the seat fitting hole 61, the first seat face M1 is axially and annularly press-fitted with the annular bottom face 61a in the axial direction to define a first seal portion S1 as a radial-direction seal portion, and the outer circumferential periphery of the seat member 31 is cylindrically press-fitted to the inner periphery defining the seat fitting hole 61 in the radial direction to define a second seal portion S2 as an axial-direction seal portion. The first seal portion S1 and the second seal portion S2 restrict oil, which is supplied to the supply port 12, from leaking through a microscopic gap between the sleeve 3 and the seat member 31 to the outside.

When the spool 4 is seated to the second seat face M2 of the seat member 31, as described above, the spool 4 substantially blockades the supply port 12 from the bleed chamber 34. If the supply port 12 is completely blockaded from the bleed chamber 34 in the condition where the spool 4 is seated to the seat member 31, oil cannot be supplied to the bleed chamber 34. In this condition, even when the bleed port 35 is blockaded by the valve 32, hydraulic pressure does not occur in the bleed chamber 34.

When the spool 4 is seated to the seat member 31, the opening of the bleed port 35 needs to be reduced by, for example, blockading the bleed port 35 in order to lift the seated spool 4. Specifically, when the bleed port 35 is blockaded, the amount of oil flowing into the bleed chamber 34 becomes larger than the amount of oil exhausted from the bleed port 35, whereby hydraulic pressure in the bleed chamber 34 is increased to lift the spool 4. In this case, hydraulic pressure as lift hydraulic pressure needs to be generated in the bleed chamber 34 in the bleed chamber 34 to lift the spool 4 from the seat member 31. Therefore, a small communication unit needs to be provided to lead oil from the supply port 12 to the bleed chamber 34 even when the spool 4 is seated to the second seat face M2.

The small communication unit is configured to reduce response time, which is required to increase the hydraulic pressure in the bleed chamber 34 to the lifting hydraulic pressure by increasing the amount of oil flowing into the bleed chamber 34 when the spool 4 is lifted from the seat member 31. However, oil leaking from the bleed chamber 34 to a low-pressure component increases when the spool 4 is seated to the seat member 31. Accordingly, high accuracy is required in manufacturing of the small communication unit so as to satisfy both the response and reduction in leakage.

According to U.S. Pat. No. 6,615,869 B2, as shown in FIG. 5A, a part of the second seat face M2 has a thin groove α as a small communication unit so as to control oil flowing into the bleed chamber 34 at an appropriate amount. A notch portion β is provided in a part of the first seat face M1 for leading oil from the supply port 12 to the thin groove α. In the present structure of U.S. Pat. No. 6,615,869 B2, the small communication unit is configured to lead oil from the supply port 12 to the bleed chamber 34 through the notch portion p and the thin groove a even when the spool 4 is seated to the seat member 31.

However, because of providing of the thin groove α and the notch portion β in the end surface of the seat member 31, the inside of the first seal portion S1 is radially communicated with the outside of the first seal portion S1. Consequently, only the second seal portion S2 has a substantial sealing structure, and the total seal length is reduced. Accordingly, in the present structure, a large amount of oil leaks from the supply port 12 to the outside through the gap between the sleeve 3 and the seat member 31.

### SUMMARY OF THE INVENTION

In view of the foregoing and other problems, it is an object of the present injection to produce a bleed valve apparatus, which has a simple structure capable of enhancing a sealing property between a sleeve and a seat member.

As described above, in the structure of U.S. Pat. No. 6,615,869 B2, the thin groove α and the notch portion β are provided in the first and second sheet bearing surfaces M1, M2 of the seat member 31, whereby oil can be supplied from the supply port 12 to the bleed chamber 34 even when the spool 4 is seated to the seat member 31. However, in the structure of U.S. Pat. No. 6,615,869 B2, because of providing of the thin groove α and the notch portion β in the end surface of the seat member 31, the inside of the first seal portion S1 is radially communicated with the outside of the first seal portion S1. Consequently, only the second seal portion S2 has a substantial sealing structure, and the total seal length is reduced. More specifically, the total seal portion between the sleeve 3 and the seal member 31 is defined not by both the first seal portion S1 and the second seal portion S2 but substantially only by the second seal portion S2. Accordingly, the structure of U.S. Pat. No. 6,615,869 B2 has a first problem that oil further leaks to the outside through the gap between the sleeve 3 and the seat member 31. Here, even a structure of an exemplified embodiment shown in FIGS. 3A to 3C similarly has the first problem. In the present exemplified embodiment, the first seat face M1 and the second seat face M2 are common seat surfaces defined in the same plane (flat surface), and the thin groove α is provided in the common seat surface. The first seat face M1 and the second seat face M2 may be defined in the same flat plane.

According to U.S. Pat. No. 6,615,869 B2, as shown in FIG. 5A, the thin groove α is provided only in the one location on the circumference of the second seat surface M2. In the condition where the spool 4 is seated to the seat member 31, the thin groove α is located between the spool 4 and the seat member 31 and defines a second orifice. The second orifice is a minute passage communicating the supply port 12 with the bleed chamber 34. Hydraulic pressure is applied from the supply port 12 to the inside of the thin groove α, which defines the second orifice. Therefore, the hydraulic pressure in the second orifice is exerted such that the spool 4 is axially spaced from the seat member 31. In the present condition, the spool 4 is inclined by being applied with the hydraulic pressure from the second orifice, which is provided to the one location distant from the center axis.

When the spool 4 is inclined by being applied with the hydraulic pressure eccentrically from the radially one side, the sliding operation of the spool 4 may by disturbed. When the sliding operation of the spool 4 is disturbed, a second problem that reduction in output characteristic of the hydraulic pressure of the solenoid hydraulic pressure control valve arises. In addition, in the structure of U.S. Pat. No. 6,615,869 B2, in the case where the spool 4 is seated to the seat member 31 and the second orifice defined by the thin groove α as the single passage is clogged with foreign matters, the amount of oil flowing into the bleed chamber 34 drastically decreases. Thus, a third problem that reduction in response of the spool 4 when being lifted from the seat member 31 arises.

In order to solve the second and third problems, as shown by the exemplified embodiment in FIGS. 3A to 3C, it is conceived to provide the thin grooves α at multiple locations such that the thin grooves α are arranged at axisymmetric positions when being viewed axially from the seat member 31. However, high accuracy is required to manufacture the thin grooves α. Accordingly, manufacturing of the thin grooves a with high accuracy requires large manpower, and consequently a fourth problem that increase in manufacturing cost arises.

According to one aspect of the present invention, a bleed valve apparatus comprises a valve body having a sliding hole, which axially extends, the valve body having an annular bottom face and an inner circumferential periphery both defining a seat fitting hole, which is substantially coaxial with the sliding hole and greater than the sliding hole in diameter. The bleed valve apparatus further comprises a spool axially movable in the sliding hole. The bleed valve apparatus further comprises a seat member being substantially cylindrical and fitted to the seat fitting hole, the seat member and the spool being configured to therebetween define a bleed chamber, the seat member having a bleed port being configured to communicate the bleed chamber with a low-pressure component. The seat member has an axial end surface, which is axially press-fitted to the annular bottom face and therebetween define an annular first seal portion. The seat member has an outer circumferential periphery, which is radially press-fitted to the inner circumferential periphery and therebetween define a cylindrical second seal portion. The spool has a spool end surface on a side of the seat member, the spool end surface having a recess, which defines a small clearance between the spool end surface and the seat member when the spool is seated to the seat member. The small clearance is configured to communicate a supply port with the bleed chamber for supplying fluid from the supply port to the bleed chamber.

### BRIEF DESCRIPTION OF THE DRAWINGS

The above and other objects, features and advantages of the present invention will become more apparent from the following detailed description made with reference to the accompanying drawings. In the drawings:

FIG. 1A is a lateral sectional view showing a solenoid hydraulic pressure control valve, FIG. 1B is a lateral sectional view showing a spool of the solenoid hydraulic pressure control valve, and FIG. 1C is a rear view of the spool, according to a first embodiment;

FIG. 2 is an enlarged sectional view showing a seal portion between components of the solenoid hydraulic pressure control valve;

FIG. 3A is a lateral sectional view showing a seat member and a sleeve of a solenoid hydraulic pressure control valve, FIG. 3B is a rear sectional view showing the seat member, and FIG. 3C is a lateral view showing the seat member;

FIG. 4 is a lateral sectional view showing a solenoid hydraulic pressure control valve according to a prior art; and

FIG. 5A is a front view showing a seat member, and FIG. 58 is a lateral sectional view showing the seat member, according to a prior art.

### DETAILED DESCRIPTION OF PREFERRED EMBODIMENTS

### First Embodiment

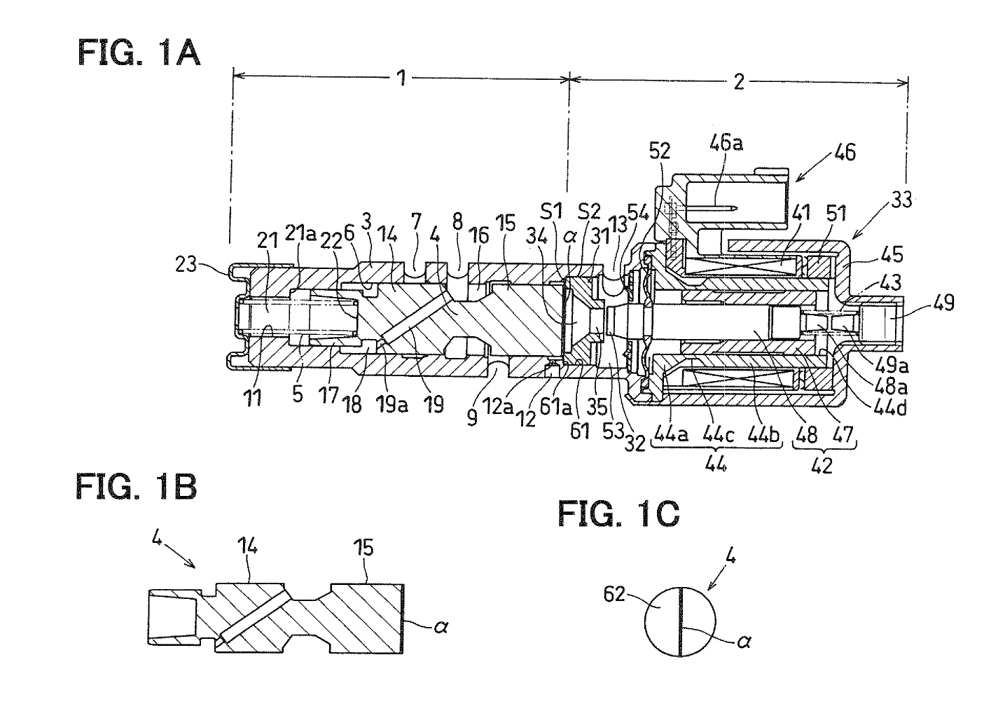

As follows, a bleed valve device will be described. According to the first embodiment, the bleed valve device is applied to a solenoid hydraulic pressure control valve. In the first embodiment, a basic structure of the solenoid hydraulic pressure control valve is first described. In the following description, the left side in FIG. 1A is defined as front, and the right side in FIG. 1A is defined as back (rear) for the sake of convenience in explanation. However, the definition of the direction of the front and rear is not limited to the direction in an actual application of the bleed valve.

(Basic Structure of Solenoid Hydraulic Pressure Control Valve)

As shown in FIG. 1A, for example, the solenoid hydraulic pressure control valve is mounted to the hydraulic pressure control device of an automatic transmission device. The solenoid hydraulic pressure control valve is constructed by combining a spool valve 1 with an electromagnetic bleed valve (solenoid bleed valve) 2. The spool valve 1 as a hydraulic pressure control valve performs switching and controlling of hydraulic pressure. The electromagnetic bleed valve 2 actuates the spool valve 1. A solenoid actuator 33 is a part of the solenoid bleed valve 2. According to the first embodiment, the solenoid hydraulic pressure control valve has a normally-Low (N/L) output structure. Specifically, a bleed port 35 is at the maximum opening when the solenoid actuator 33 is turned OFF. In the present condition where the solenoid actuator 33 is turned OFF, an input port 7 and an output port 8 are at minimum communication therebetween, and the output port 8 and an exhaust port 9 are at maximum communication therebetween. That is, the input port 7 is substantially blockaded from the output port 8, and the output port 8 is communicated with the exhaust port 9.

(Description of Spool Valve 1)

The spool valve 1 includes a sleeve 3, a spool 4, and a spool-return spring 5. The sleeve 3 as a valve body is inserted into a case of an unillustrated hydraulic controller. The sleeve 3 is in a substantially cylindrical shape. The sleeve 3 has an insertion hole 6, an inlet port 7, an outlet port 8, and the exhaust port 9. The insertion hole 6 holds the spool 4 such that the spool 4 is slidable axially relative to the insertion hole 6. The input port 7 is communicated with an oil outlet port of an oil pump as a hydraulic pressure generating unit through a passage or the like and applied with input hydraulic pressure from oil, which is supplied from the oil pump. The output port 8 applies output hydraulic pressure, which is regulated in the spool valve 1. The exhaust port 9 is communicated with a low-pressure component such as an oil sump.

The sleeve 3 has the left end as the front end in FIG. 1A, and the front end has a spring insertion hole 11 through which the spool-return spring 5 is inserted into the sleeve 3. The oil ports including the input port 7, the output port 8, and the exhaust port 9 are through holes, which are provided in the lateral side of the sleeve 3. Specifically, the input port 7, the output port 8, the exhaust port 9, a supply port 12, and a bleed exhaust port 13 are provided on the lateral side of the sleeve 3 and arranged in order from the front to the rear side in FIG. 1A. A bleed chamber 34 is supplied with oil through the supply port 12. The bleed chamber 34 bleeds oil to a low-pressure component outside of the sleeve 3 through the bleed exhaust port 13.

The supply port 12 is provided with a control orifice 12a as a first orifice for regulating the maximum flow of oil that passes through the supply port 12, thereby regulating consumption of oil when a valve 32 is opened. The supply port 12 communicates with the input port 7 through a pressure regulator valve at the outside of the sleeve 3 within the unillustrated hydraulic pressure controller. The exhaust port 9 communicates with the bleed exhaust port 13 at the outside of the sleeve 3 within the hydraulic pressure controller.

The spool 4 is slidable in the sleeve 3, and includes an input seal land 14 and an exhaust seal land 15. The input seal land 14 is capable of blockading the input port 7. The exhaust seal land 15 is capable of blockading the exhaust port 9. The input seal land 14 and the exhaust seal land 15 have a distribution chamber 16 therebetween. The spool 4 has a feedback land 17 at the front side of the input seal land 14 in FIG. 1A. The feedback land 17 is smaller than the input seal land 14 in diameter. The input seal land 14 and the feedback land 17 therebetween have a land difference (difference in diameter) and define a feedback chamber 18. The spool 4 therein has a feedback port 19, which communicates the distribution chamber 16 with the feedback chamber 18 to generate F/B hydraulic pressure in the feedback chamber 18 according to the output pressure. The feedback port 19 is provided with a feedback orifice 19a to suitably generate F/B hydraulic pressure in the feedback chamber 18.

In the present structure, as hydraulic pressure (outlet pressure) in the feedback chamber 18 becomes greater, differential pressure applied to the spool 4 becomes greater in accordance with the difference (land difference) between the inlet seal land 14 and the feedback land 17. Thus, axial force is applied to the spool 4 to displace the spool 4 toward the rear in FIG. 1A. In this operation, the movement of the spool 4 is stabilized, so that outlet pressure can be stabilized regardless of variation in inlet pressure. The spool 4 is maintained at a position where the spring force of the spool-return spring 5, the driving force, which is generated by pressure in the bleed chamber 34 and applied to the spool 4, and the axial force applied to the spool 4 correspondingly to the land difference between the inlet seal land 14 and the feedback land 17 balance thereamong.

The spool-return spring 5 is a coil spring being in a cylindrical helical spring, which is compressed and received in a spring chamber 21 of the sleeve 3. In this embodiment, the spool-return spring 5 biases the spool 4 toward a valve closing side on the rear side in FIG. 1A, such that the length (inlet seal length) of the seal in the inlet becomes large to decrease the outlet pressure. The spool-return spring 5 is in contact with the bottom surface of a recess 22 at one end. The recess 22 is provided in the feedback land 17. The spool-return spring 5 is held by being in contact with the bottom surface of a spring seat 23 at the other end. The spring seat 23 is fixed to the front end of the sleeve 3 in FIG. 1A by being welded, caulked, or the like. The spring chamber 21 has a step 21a, which determines the maximum open position as a maximum lift position of the spool 4 by making contact with the front end of the spool 4 in FIG. 1A.

(Description of Solenoid Bleed Valve 2)

The solenoid bleed valve 2 is configured to actuate the spool 4 to the front side in FIG. 1A according to pressure in the bleed chamber 34, which is provided at the rear side of the spool 4 in FIG. 1A. The solenoid bleed valve 2 is constructed of a seat member 31 and the solenoid actuator 33, which is provided with the valve 32. The seat member 31 is substantially in a cylindrical shape and fixed inside the sleeve 3 at the rear side in FIG. 1A. The seat member 31 and the spool 4 therebetween define the bleed chamber 34 to actuate the spool 4. The seat member 31 has a center portion, which has the bleed port 35. The bleed port 35 is configured to communicate the bleed chamber 34 with the bleed exhaust port 13 at low-pressure. The seat member 31 has the end surface on the front side in FIG. 1A and the end surface is configured to be seated with the spool 4, thereby determining the maximum close position as a spool seated position of the spool 4. The seat member 31 has the end surface at the rear side in FIG. 1A, and the end surface is configured to make contact with the valve 32, which is provided in the front end of a shaft 48. The valve 32 is configured to make contact with the end surface of the seat member 31 at the rear side in FIG. 1A, thereby blockading the bleed port 35.

The solenoid actuator 33 includes a coil 41, a movable element 42, a return spring 43 for the movable element 42, a stator 44, a yoke 45, and a connector 46. The solenoid actuator 33 is configured to actuate the valve 32 so as to control communication through the bleed port 35. When the valve 32 decreases communication through the bleed port 35, pressure in the bleed chamber 34 increases, whereby the spool 4 is displaced in the opening direction to the front side in FIG. 1A. Conversely, when the valve 32 increases communication through the bleed port 35, pressure in the bleed chamber 34 decreases, whereby the spool 4 is displaced in the closing direction to the rear side in FIG. 1A.

The coil 41 is configured to generate magnetism when being energized, thereby forming a magnetic flux loop, which passes through the movable element 42 (the moving core 47) and a magnetism stator, which includes the stator 44 and the yoke 45. The coil 41 is constructed by winding a wire, which is coated with an insulative material, around the circumference of a resin bobbin. The movable element 42 includes a moving core 47 and the shaft 48. The moving core 47 is in a cylindrical shape and magnetically attracted by the magnetism, which the coil 41 axially generates. The shaft 48 is press-fitted into the moving core 47 and provided with the valve 32 at the axial end. The moving core 47 is formed of a magnetic metal such as iron to be substantially in an annular column shape for defining the magnetic circuit. The moving core 47 is directly slidable on the inner periphery of the stator 44. The shaft 48 is formed from a nonmagnetic material, such as stainless steel, being high in hardness. The shaft 48 is substantially in a stick shape and press-fitted to be fixed to the moving core 47. The shaft 48 is provided with the valve 32 at the front end in FIG. 1A to open and close the bleed port 35.

The return spring 43 is a coil spring, which is formed by winding a wire to be in a cylindrical shape to bias the shaft 48 in the closing direction such that the valve 32 closes the bleed port 35. The return spring 43 is maintained in a state where being compressed between the end of the shaft 48 at the rear side in FIG. 1A and an adjuster (adjusting screw) 49. The adjuster 49 is axially screwed into the center portion of the yoke 45. In the solenoid bleed valve 2 according to the present first embodiment, when the solenoid actuator 33 is turned OFF and the moving core 47 is not applied with magnetism, which is directed to the front side in FIG. 1A, the valve 32 moves to the rear side in FIG. 1A by being applied with exhaust pressure of oil from the bleed port 35, thereby opening the bleed port 35. The return spring 43 is configured to apply biasing force to the movable element 42 for controlling a characteristic of the movable element 42. Specifically, the return spring 43 exerts spring force such that the shaft 48 can be moved to the rear side in FIG. 1A by being applied with exhaust pressure of the oil from the bleed port 35 when the solenoid actuator 33 is turned OFF. The spring load of the return spring 43 is adjusted according to a length by which the adjuster 49 is screwed.

The rear end of the shaft 48 in FIG. 1A is provided with a shaft-end projected portion 48a, which extends to the rear side in FIG. 1A inside the return spring 43. The front end of the adjuster 49 in FIG. 1A is provided with an adjuster-end projected portion 49a, which extends to the front side in FIG. 1A inside the return spring 43. The shaft-end projected portion 48a and the adjuster-end projected portion 49a makes contact with each other when the shaft 48 is displaced to the rear side in FIG. 1A.

The stator 44 is made from a magnetic metallic material such as iron. In particular, the stator 44 is made from a ferromagnetic material, which configures a magnetic circuit. The stator 44 includes an attracting stator 44a and a slidable stator 44b. The stator 44 has a magnetism saturation groove 44c. The attracting stator 44a magnetically attracts the moving core 47 in the axial direction toward the front side in FIG. 1A in the direction, in which the valve 32 closes the bleed port 35. The slidable stator 44b surrounds the circumference of the moving core 47 and transmits the magnetic flux to the moving core 47 in the radial direction. The magnetism saturation groove 44c is a portion in which magnetic resistance becomes large. The magnetism saturation groove 44c suppresses the magnetic flux passing between the attracting stator 44a and the slidable stator 44b, thereby leading the magnetic flux through the attracting stator 44a, the moving core 47, and the slidable stator 44b in order. The inner circumferential periphery of the stator 44 defines an axial hole 44d, which supports the moving core 47 such that the moving core 47 is slidable therein. The axial hole 44d is a through hole substantially uniform in inner diameter from one end of the stator 44 toward the other end of the stator 44.

The attracting stator 44a is magnetically joined with the yoke 45 via a flange, which is axially interposed between the yoke 45 and the sleeve 3. The attracting stator 44a includes a cylindrical portion, which radially overlaps with the moving core 47 when attracting the moving core 47. The cylindrical portion has the circumferential periphery, which is in a tapered shape such that magnetic attractive force does not change accompanied with change in the stroke of the moving core 47.

The slidable stator 44b is substantially in a cylindrical shape and entirely surrounds the circumferential periphery of the moving core 47. A magnetism transmission ring 51 is provided on the outer circumferential periphery of the slidable stator 44b. The magnetism transmission ring 51 is formed from a magnetic material such as iron. In particular, the magnetism transmission ring 51 is formed from a ferromagnetic material, which configures a magnetic circuit. In the present structure, the slidable stator 44b and the yoke 45 are magnetically joined. The slidable stator 44b is configured to support the moving core 47 inside the axial hole 44d such that the moving core 47 is axially slidable directly on the slidable stator 44b. The slidable stator 44b also transmits the magnetic flux with the moving core 47 in the radial direction. The yoke 45 is formed of a magnetic metallic material such as iron to be substantially in a cup shape to surround the coil 41. In particular, the yoke 45 is formed from a ferromagnetic material, which configures a magnetic circuit. The yoke 45 is firmly joined with the sleeve 3 by crimping a claw portion, which is provided in the open end thereof.

The sleeve 3 is connected with the yoke 45 via a connecting portion, which is provided with a diaphragm 52 for partitioning the interior of the sleeve 3 from the interior of the solenoid actuator 33. The diaphragm 52 is formed from rubber to be substantially in a ring shape. The diaphragm 52 has an outer circumferential portion interposed between the sleeve 3 and the stator 44. The diaphragm 52 has a center portion fitted to a groove, which is formed in the outer circumferential periphery of the shaft 48. In the present structure, the diaphragm 52 protects the solenoid actuator 33 from intrusion of oil and foreign matters from an exhaust-gas-pressure chamber 53 in the sleeve 3. The exhaust-gas-pressure chamber 53 is provided in the sleeve 3 on the rear side in FIG. 1A. The exhaust-gas-pressure chamber 53 is partitioned by the seat member 31 and the diaphragm 52. The exhaust-gas-pressure chamber 53 communicates with the bleed exhaust port 13. A pressure shield 54 is a substantially ring-shaped plate and provided at the side of the exhaust-gas-pressure chamber 53 with respect to the diaphragm 52 to restrict pressure in the exhaust-gas-pressure chamber 53 from being directly applied to the diaphragm 52.

The connector 46 electrically connects with an electronic control unit as an AT-ECU (not shown) via a lead wire. The electronic control unit is for controlling the solenoid hydraulic pressure control valve. The connector 46 accommodates a terminal 46a, which is connected with both ends of the coil 41. The electronic control unit is configured to perform a duty-ratio control of an electric current supplied to the coil 41 of the solenoid actuator 33, Whereby, the electronic control unit continuously manipulates the axial position of the movable element 42, which includes the moving core 47 and the shaft 48, against the exhaust pressure of oil in the bleed port 35 by manipulating the electric current supplied to the coil 41. In such a manner, the electronic control unit continuously manipulates the axial position of the valve 32 by changing the axial position of the movable element 42 so as to control the lift of the bleed port 35. Thus, the electronic control unit controls the hydraulic pressure in the bleed chamber 34.

In the present structure, the electronic control unit controls the hydraulic pressure in the bleed chamber 34, thereby manipulating the axial position of the spool 4. Thus, the ratio between an input side seal length and an exhaust side seal length is controlled. Here, the input side seal length is defined by the input seal land 14 and associated with communication between the input port 7 and the distribution chamber 16. The exhaust side seal length is defined by the exhaust seal land 15 and associated with communication between the distribution chamber 16 and the exhaust port 9. Consequently, the output hydraulic pressure in the output port 8 is controlled.

### Feature of First Embodiment

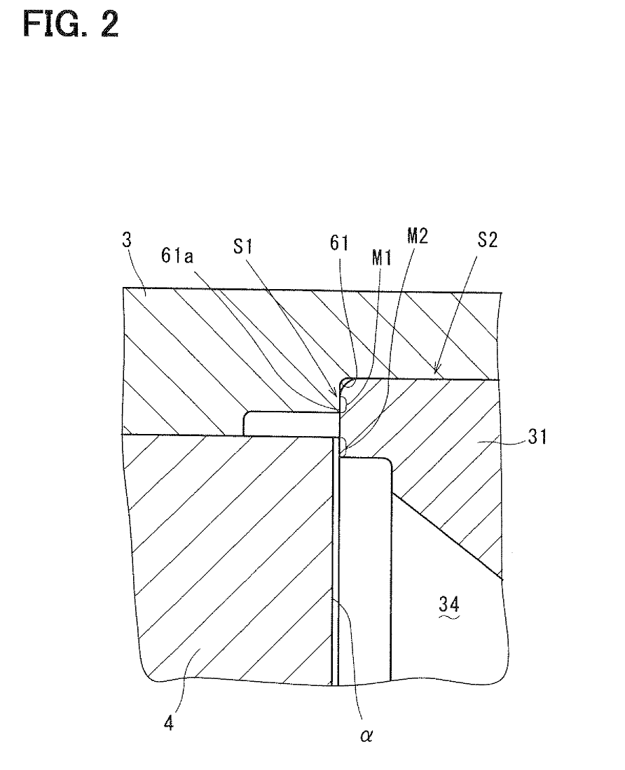

First, a detailed joint structure between the seat member 31 and the sleeve 3 is described with reference to FIG. 1A to FIG. 2. The seat member 31 is fixed to the inside of the sleeve 3 on the rear side in FIG. 1A. The sleeve 3 on the right side in FIG. 1A has a seat fitting hole 61 through which the seat member 31 is inserted into the sleeve 3. The seat fitting hole 61 as a cylindrical bore is substantially coaxial with the sliding hole 6 and has the diameter larger than the diameter of the sliding hole 6. The seat fitting hole 61 has the front end as the bottom end, which defines a step between the sliding hole 6 and the seat fitting hole 61. More strictly, the step is defined between an annular groove communicated with the supply port 12 and the seat fitting hole 61. The step of the seat fitting hole 61 defines an annular bottom face 61a (FIG. 2). The annular bottom face 61a defines a surface, which is perpendicular to the center axis of the sleeve 3.

The seat member 31 is in a substantially cylindrical shape. The seat member 31 is steadily press-fitted from the rear side of the seat fitting hole 61 toward the front side and thereby fixed to the sleeve 3. The front end face of the seat member 31 is perpendicular to the center axis of the seat member 31 and defines a first seat face M1 and a second seat face M2. The seat member 31 is fixed to the sleeve 3 by being press-fitted into the seat fitting hole 61. The front end face of the seat member 31 is in press-contact with the annular bottom face 61a steadily in the axial direction, thereby defining an annular first seal portion S1. The outer circumferential periphery of the seat member 31 is radially press-fitted to the inner circumference periphery defining the seat fitting hole 61, thereby defining a cylindrical second seal portion S2. The first seal portion S1 and second seal portion S2 restrict oil, which is supplied into the sleeve 3 through the supply port 12, from leaking to the outside through a contact portion between the sleeve 3 and the seat member 31.

The front end face of the seat member 31 has the first seat face M1, which is in press-contact with the annular bottom face 61a. The front end face of the seat member 31 has the second seat face M2, to which the spool 4 is seated. In the present embodiment, the first seat face M1 and the second seat face M2 are defined substantially on the same plane. That is, the first seat face M1 and the second seat face M2 are defined as a common seat face.

Next, a small communication unit is described. The small communication unit is configured to generate lifting hydraulic pressure in the bleed chamber 34. The seat member 31 is an annular member and has the bleed chamber 34 therein. The front end face of the seat member 31 has the annular second seat face M2, to which the spool 4 is seated. When the spool 4 is seated to the second seat face M2 of the seat member 31, the supply port 12 is substantially blockaded from the bleed chamber 34 by the spool 4. Thus, consumption of oil exhausted through the supply port 12, the bleed chamber 34, and the bleed port 35 in order is restricted.

If the supply port 12 is completely blockaded from the bleed chamber 34 in the condition where the spool 4 is seated to the seat member 31, oil cannot be supplied to the bleed chamber 34. In this condition, even when the bleed port 35 is blockaded by the valve 32, hydraulic pressure does not occur in the bleed chamber 34. Therefore, in the present structure, the small communication unit is provided to lead oil from the supply port 12 to the bleed chamber 34 even when the spool 4 is seated to the seat member 31.

### Back Ground of First Embodiment 1

According to U.S. Pat. No. 6,615,869 B2, as shown in FIG. 5A, a part of the second seat face M2 has a thin groove α as a small communication unit so as to control oil flowing into the bleed chamber 34 at an appropriate amount. A notch portion β is provided in a part of the first seat face M1 for leading oil from the supply port 12 to the thin groove α.

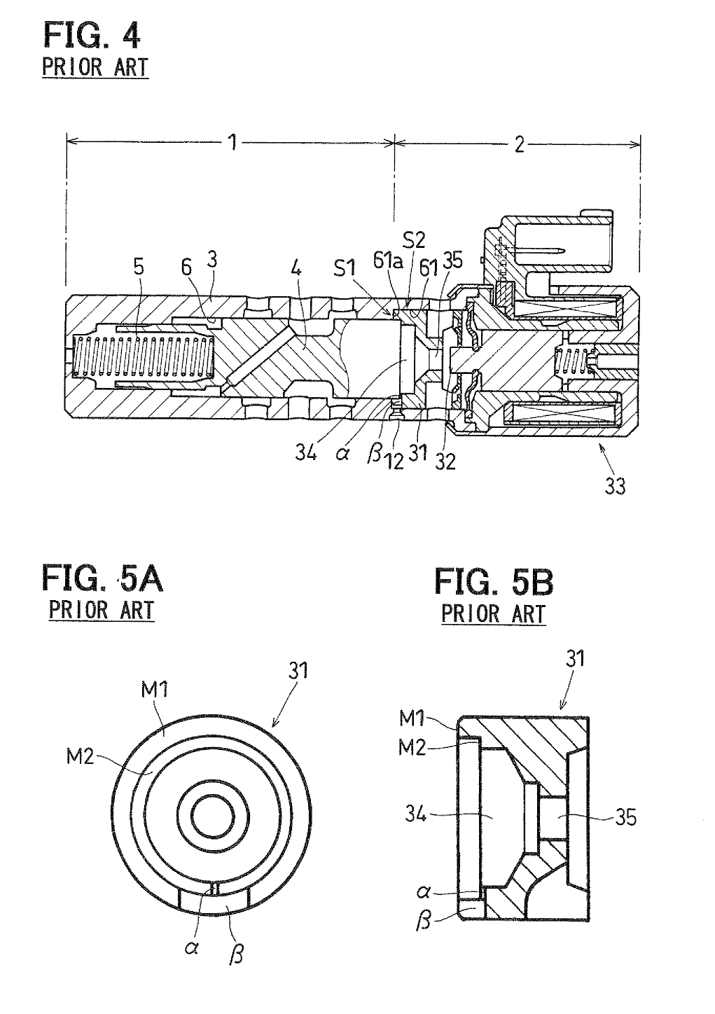

However, since the thin groove α and the notch portion β are provided, as shown in FIG. 4, the inside of the first seal portion S1 is radially communicated with the outside of the first seal portion S1. Consequently, the first seal portion S1 cannot serve as an oil seal. Therefore, in the structure of U.S. Pat. No. 6,615,869 B2, only the second seal portion S2 serves as a substantial seal oil, and the total seal length is reduced. Accordingly, the present structure has a first problem that oil further leaks to the outside through the gap between the sleeve 3 and the seat member 31.

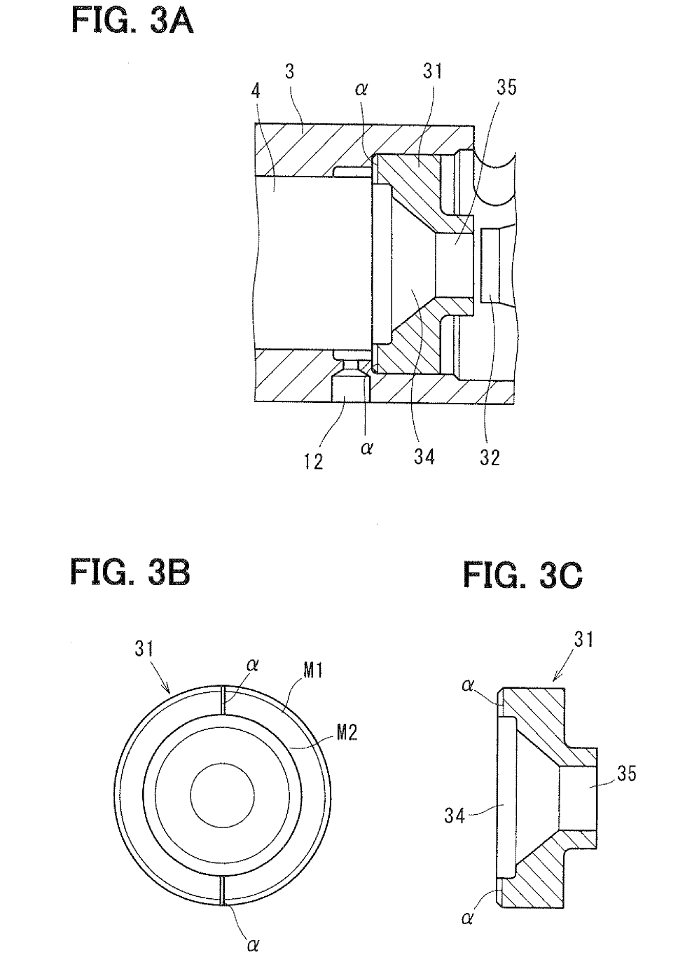

Here, even a structure of an exemplified embodiment shown in FIGS. 3A to 3C similarly has the first problem. In the present exemplified embodiment, the first seat face M1 and the second seat face M2 are common seat surfaces defined in the same plane, and the thin groove α is provided in the common seat surface. The exemplified embodiment shown in FIGS. 3A to 3C is not a prior art.

### Back Ground of First Embodiment 2

According to U.S. Pat. No. 6,615,869 B2, as shown in FIG. 5A, the thin groove α is provided only to the one location on the circumference of the second seat surface M2. In the condition where the spool 4 is seated to the seat member 31, the thin groove α is located between the spool 4 and the seat member 31 and defines a second orifice. The second orifice is a minute passage communicating the supply port 12 with the bleed chamber 34. Hydraulic pressure is applied from the supply port 12 to the inside of the thin groove α, which defines the second orifice. Therefore, the hydraulic pressure in the second orifice is exerted such that the spool 4 is axially spaced from the seat member 31. In the present condition, the spool 4 is inclined by being applied with the hydraulic pressure from the second orifice, which is provided to the one location being distant from the center axis.

When the spool 4 is inclined by being applied with the hydraulic pressure eccentrically from the radially one side, the sliding operation of the spool 4 may by disturbed. When the sliding operation of the spool 4 is disturbed, a second problem that reduction in output characteristic of the hydraulic pressure arises. In addition, in the present structure, the second orifice as the thin groove α is provided only in the one location of the seat member 31. Therefore, in the case where the spool 4 is seated to the seat member 31 and the second orifice as the single passage is clogged with foreign matters, the amount of oil flowing into the bleed chamber 34 drastically decreases. Thus, a third problem that reduction in response of the spool 4 when being lifted from the seat member 31 arises.

In order to solve the second and third problems, as shown by the exemplified embodiment in FIGS. 3A to 3C, it is conceived to provide the thin grooves α at two locations such that the thin grooves α are arranged at axisymmetric positions, when being viewed axially from the seat member 31. In this case, the hydraulic pressure generated in the second orifices is axisymmetrically applied to the spool 4. However, high accuracy is required to manufacture the thin grooves α. Accordingly, manufacturing of the thin grooves a with high accuracy requires large manpower, and consequently a fourth problem that increase in manufacturing cost arises.

(One Feature for Solving First to Fourth Problems)

In order to solve the first to fourth problems, the present first embodiment has the following structure as one feature. In the present first embodiment, the spool 4 has a spool rear end face 62, which is equivalent to a spool end surface, at the side of the seat member 31, and the spool rear end face 62 has a recess as the small communication unit. The recess on the spool rear end face 62 defines a small clearance with respect to the seat member 31 so as to minutely communicate the supply port 12 with the bleed chamber 34 in the condition where the spool 4 is seated to the seat member 31.

More specifically, the recess in the present first embodiment is a minute and thin groove α, which is provided as the small communication unit and configured to lead oil from the supply port 12 to the bleed chamber 34 when the spool 4 is seated to the seat member 31. In further detail, as shown in FIG. 1C, the thin groove α is a single line, which extends from the outer circumferential periphery of the spool rear end face 62 through the center of the spool rear end face 62 and reaches the outer circumferential periphery of the spool rear end face 62. The single thin groove a defines two second orifices at two locations on the circumference of the second seat face M2, which is opposed to the spool rear end face 62, when the spool 4 is seated to the seat member 31.

As follows, passage areas of the second orifices, which are defined by the thin groove α, are described. Oil flowing into the bleed chamber 34 through the second orifices can be increased by enlarging the passage areas of the second orifices, that is, by increasing the sectional area of the thin groove α. Thus, hydraulic pressure in the bleed chamber 34 can be quickly increased to the lift hydraulic pressure. Consequently, response of the spool 4 when being lifted from the seat member 31 can be enhanced. When the spool 4 is seated to the seat member 31, the valve 32 opens the bleed port 35. Therefore, when the passage area of the second orifice is enlarged, the amount of oil leaking from the second orifice to the low-pressure component through the bleed chamber 34 increases. That is, the response when the spool 4 is lifted from the seat member 31 and the leakage of oil when the spool 4 is seated to the seat member 31 are in conflict. Therefore, the passage areas of the second orifices, that is, the width and the depth of the thin groove α are determined so as to satisfy the response and suppress the leakage within a suitable limit.

### Operation of First Embodiment

Next, an operation of the solenoid hydraulic pressure control valve is described. In a state where energization of the solenoid actuator 33 is stopped, the valve 32 is biased to the rear side in FIG. 1A by being applied with the exhaust pressure of oil from the bleed port 35. Therefore, the movable element 42, which includes the moving core 47 and the shaft 48, is displaced to the rear side in FIG. 1A, whereby the opening of the bleed port 35 is enlarged. Thus, the bleed chamber 34 is in a pressure-exhausting state to release pressure therefrom, thereby the spool 4 is seated to the seat member 31 and stopped at the maximum close position as a spool seated position. In the present condition, when the spool 4 stops at the maximum close position, communication between the input port 7 and the output port 8 becomes minimum, whereby the input port 7 is blockaded from the output port 8. In addition, in the present condition, communication between the output port 8 and the exhaust port 9 becomes maximum, whereby the output port 8 is in the pressure-exhausting state to release pressure therethrough.

When a driving current is supplied to the solenoid actuator 33, which is being de-energized, the magnetic attractive force is exerted to move the moving core 47 to the front side in FIG. 1A. Thus, the movable element 42, which includes the moving core 47 and the shaft 48, is displaced to the front side in FIG. 1A, whereby the opening of the bleed port 35 is reduced. Then, the amount of oil, which is supplied to the bleed chamber 34 through the second orifices defined by the single small groove α, exceeds the amount of oil, which is exhausted from the bleed port 35. Thus, the hydraulic pressure in the bleed chamber 34 increases. When the hydraulic pressure in the bleed chamber 34 reaches the lift hydraulic pressure, the spool 4 is lifted from the seat member 31. When the spool 4 is lifted from the seat member 31, the clearance between the spool rear end face 62 and the second seated surface M2 (FIG. 2) is enlarged. Whereby, the amount of oil flowing into the bleed chamber 34 through the supply port 12 increases.

As the driving current is further supplied to the solenoid actuator 33, the opening of the bleed port 35 becomes small. Consequently, pressure in the bleed chamber 34 increases, whereby the spool 4 is moved to the front side in FIG. 1A against the biasing force of the spool-return spring 5. That is, as the driving current supplied to the solenoid actuator 33 increases, the communication between the output port 8 and the exhaust port 9 decreases, and the communication between the input port 7 and the output port 8 increases. Whereby, the pressure in the output port 8 increases.

When the valve 32 makes contact with the seat member 31 to blockade the bleed port 35 accompanied with further increase in driving current supplied to the solenoid actuator 33, pressure in the bleed chamber 34 becomes maximum by being supplied with oil from the supply port 12. Thus, the spool 4 is further moved to the front side in FIG. 1A against the biasing force of the spool-return spring 5. In the present condition, the communication between the input port 7 and the output port 8 becomes maximum, and the communication between the output port 8 and the exhaust port 9 becomes minimum, that is, the output port 8 is blockaded from the exhaust port 9. Thus, the output pressure in the output port 8 becomes maximum.

The spool 4 is maintained at a balanced position in the state of the present maximum output. Specifically, the spool 4 is maintained at an axial position, in which the pressure applied from the bleed chamber 34 to the rear end surface of the spool 4 in FIG. 1A, the spring load of the spool-return spring 5, and the axial force generated by the feedback operation when the maximum output pressure as the input pressure is applied to the feedback chamber 18. In general, the balanced position of the spool 4 at the time of the maximum output is at the rear side of the maximum open position of the spool 4 (spool maximum lift position). At the balanced position, the spool 4 is not in contact with the step 21a of the spring chamber 21.

An operation contrary to the above operation is performed when the driving current of the solenoid actuator 33 decreases. In this case, when energization of the solenoid actuator 33 is stopped, the spool 4 is seated to the seat member 31 again and positioned at the maximum close position (spool seated position).

### Effect of First Embodiment

As described above, according to the present first embodiment, the thin groove α is provided as the small communication unit in the spool rear end face 62 so as to define a minute communication between the supply port 12 and the bleed chamber 34 in the state where the spool 4 is seated to the seat member 31.

Referring to FIG. 2, the thin groove a or the like, which radially communicates the inside of the first seal portion S1 with the outside of the first seal portion S1, is not provided to the first seal portion S1. Therefore, the first problem of the communication between the inside and the outside of the seal portion S1 through the thin groove a or the like can be solved. In the present structure, both the first seal portion S1 and second seal portion S2 seal between the sleeve 3 and the seal member 311 so that leakage of oil through the gap between the sleeve 3 and the seal member 31 can be reduced. That is, in the present first embodiment, the sealing performance between the spool 4 and the seat member 31 can be enhanced by employing the simple structure having the thin groove a in the spool rear end face 62.

In the present first embodiment, the thin groove α is a single line, which extends from the outer circumferential periphery of the spool rear end face 62 through the center of the spool rear end face 62 and reaches the outer circumferential periphery of the spool rear end face 62. The single thin groove a in the spool rear end face 62 defines the two second orifices at the two locations, which are axisymmetric to each other. Accordingly, the hydraulic pressure is applied at the two locations, which are axisymmetric with each other, in the spool rear end face 62 to axially space the spool 4 from the seat member 31. Thus, the spool 4 can be restricted from being inclined. Consequently, the second problem can be solved. In the present structure, the second orifices are axisymmetrically provided and the spool 4 is restricted from being inclined. That is, the second orifices are radially opposed to each other. Therefore, the sliding property of the spool 4 can be maintained, and the output property of the hydraulic pressure can be also maintained.

In the present first embodiment, the single thin groove a in the spool rear end face 62 defines the two second orifices at the two locations. Therefore, even in the case where one of the second orifices is clogged with foreign matters, oil can be led to the bleed chamber 34 through the other second orifice. Consequently, the third problem can be solved. In the present structure, the response at the time of lifting of the spool 4 from the seat member 31 can be maintained, since oil can be led to the bleed chamber 34 through the other second orifice when the one second orifice is closed.

Further, according to the present first embodiment, the two second orifices, which restrict the spool 4 from being inclined and maintain the response, are provided by the single thin groove α as the recess. Therefore, manpower and a manufacturing cost needed for manufacturing the thin groove a can be maintained small. Consequently, the fourth problem can be solved. Accordingly, increase in manufacturing cost can be suppressed, and inclination of the spool 4 can be restricted. Furthermore, the response can be maintained.

In the present first embodiment, the first seat face M1 and the second seat face M2 are provided in the same plane of the seat member 31. The first seat face M1 and the second seat face M2 are provided to define the common seat surface. Thus, by providing the first seat face M1 and the second seat face M2 to define the common seat surface at the same plane, the shape of the seat member 31 can be simplified, and the manufacturing cost of the seat member 31 can be reduced.

(Modification)

In the first embodiment, the first seat face M1 and the second seat face M2 are provided in the same plane of the seat member 31 to define the common seat surface. Alternatively, the first seat face M1 and the second seat face M2 may be located at axially different locations, similarly to the U.S. Pat. No. 6,615,869 B2.

In the first embodiment, the thin groove α is the single line, which extends from the outer circumferential periphery of the spool rear end face 62 through the center of the spool rear end face 62 and reaches the outer circumferential periphery of the spool rear end face 62. Alternatively, the thin groove a may extend from the outer circumferential periphery of the spool rear end face 62 to an intermediate portion so as to reach the bleed chamber 34. In the present structure, the first problem can be solved.

In the first embodiment, the thin groove α is provided as an example of the recess. Alternatively, the recess may be in another shape. The recess may be, for example, a step or a combination of a minute recess and a minute protrusion and provided in the spool rear end face 62. In the case where a step as an example of the recess is provided to the spool rear end face 62, communication between the supply port 12 and the bleed chamber 34 when the spool 4 is seated to the seat member 31 can be controlled by adjusting the location of the step. Thus, the leakage amount can be suitably regulated while the response is maintained.

In the first embodiment, the seat member 31 is press-fitted into the seat fitting hole 61. Alternatively, the seat member 31 may be fitted to the seat fitting hole 61 by another method such as crimping to cause plastic deformation therein.

In the first embodiment, the opening of the bleed port 35 is maximum when the solenoid actuator 33 is de-energized. Alternatively, the bleed port 35 may be blockaded when the solenoid actuator 33 is de-energized.

In the first embodiment, the solenoid hydraulic pressure control valve has the normally-Low (N/L) output structure, in which the communication between the input port 7 and the output port 8 becomes minimum when the solenoid actuator 33 is de-energized, whereby the communication between the output port 8 and the exhaust port 9 becomes maximum. Alternatively, the solenoid hydraulic pressure control valve may have a normally-high (N/H) output structure, in which the communication between the input port 7 and the output port 8 becomes maximum when the solenoid actuator 33 is de-energized, whereby the communication between the output port 8 and the exhaust port 9 becomes minimum.

According to the embodiments, the spool valve 1 is a three-way valve. However, the spool valve 1 is not limited to the three-way valve. The spool valve 1 may be a two-way valve (ON OFF valve) or a four-way valve, for example.

According to the above embodiments, the solenoid actuator 33 is employed as one example of an open-close unit. Alternatively, other electric actuators such as an electric motor or a piezo actuator, which includes a piezo stack, may be employed as the open-close unit.

According to the embodiments, the hydraulic pressure control valve having the present structure is used for the automatic transmission device. Alternatively, the present hydraulic pressure control valve may be applied to other devices than an automatic transmission device.

According to the embodiments, the present characterized structure is applied to the hydraulic pressure control valve. Alternatively, the present characterized structure may be applied to an oil flow control valve (OCV) for controlling an oil flow.

The oil used for the hydraulic pressure control valve is an example. Other hydraulic fluid can be used instead of oil.

The above structures of the embodiments can be combined as appropriate. Various modifications and alternations may be diversely made to the above embodiments without departing from the spirit of the present invention.

What is claimed is:

1. A bleed valve apparatus comprising:
a valve body having a sliding hole, which axially extends, the valve body having an annular bottom face and an inner circumferential periphery both defining a seat fitting hole, which is substantially coaxial with the sliding hole and greater than the sliding hole in diameter,
a spool axially movable in the sliding hole; and
a seat member being substantially cylindrical and fitted to the seat fitting hole, the seat member and the spool being configured to therebetween define a bleed chamber, the seat member having a bleed port being configured to communicate the bleed chamber with a low-pressure component,
wherein the seat member has an axial end surface, which is axially press-fitted to the annular bottom face and therebetween define an annular first seal portion,
the seat member has an outer circumferential periphery, which is radially press-fitted to the inner circumferential periphery and therebetween define a cylindrical second seal portion,
the spool has a spool end surface on a side of the seat member, the spool end surface having a recess, which defines a small clearance between the spool end surface and the seat member when the spool is seated to the seat member, and
the small clearance is configured to communicate a supply port with the bleed chamber for supplying fluid from the supply port to the bleed chamber.

2. The bleed valve apparatus according to claim 1,
wherein the recess is a single thin groove, which extends linearly from one location of an outer circumferential periphery of the spool end surface to an other location of the outer circumferential periphery of the spool end surface, and
the single thin groove passes substantially through a center of the spool end surface.

3. The bleed valve apparatus according to claim 1,
wherein the seat member has a first seat face and a second seat face,
the first seat face is axially press-fitted to the annular bottom face,
the second seat face is configured to be seated with the spool, and
the first seat face and the second seat face are defined in a same flat surface of the seat member.

4. The bleed valve apparatus according to claim 1, further comprising:
an open-close unit configured to open and close the bleed port.

5. The bleed valve apparatus according to claim 4,
wherein the annular first seal portion and the cylindrical second seal portion respectively axially and radially seal between the seat member and the valve body, and
the bleed chamber communicates with the supply port only through the small clearance when the spool is seated to the seat member and the open-close unit blockades the bleed port.

6. The bleed valve apparatus according to claim 1, wherein the small clearance is configured to supply fluid therethrough from the supply port into the bleed chamber to apply pressure of the fluid to the spool end surface to lift the spool from the seat member when the spool is seated to the seat member and the bleed port is blockaded.

7. The bleed valve apparatus according to claim 1,
wherein the recess is a single thin groove, which extends linearly from one location of an outer circumferential periphery of the spool end surface to an other location of the outer circumferential periphery of the spool end surface, and
the single thin groove defines a pair of orifices at the one location and the other location when the spool is seated to the seat member.

8. The bleed valve apparatus according to claim 7, wherein the pair of orifices which are substantially axisymmetric to each other with respect to a center axis of the seat member.

9. The bleed valve apparatus according to claim 7, wherein the pair of orifices are radially opposed to each other.

10. The bleed valve apparatus according to claim 1, wherein the valve body has the supply port.
